(19) United States
(12) Patent Application Publication
(10) Pub. No.: US 2026/0326292 A1
(43) Pub. Date: Oct. 22, 2026

(54) PREDICTIVE ACTUATION GATING IN PHYSICAL ARTIFICIAL INTELLIGENCE

(71) Applicant: Dorian Cartwright, San Jose, CA (US)

(72) Inventor: Dorian Cartwright, San Jose, CA (US)

(21) Appl. No.: 19/638,074

(22) Filed: Apr. 2, 2026

(51) Int. Cl. B25J 9/16

(52) U.S. Cl. CPC B25J 9/163; B25J 9/1661; B25J 9/1694

(57) ABSTRACT

A candidate action generated for a physical artificial intelligence system is intercepted before motor release and evaluated using one or more predictive validators. A predictive actuation validator estimates macro-scale risks including collision, instability, excessive force, loss of object retention, or unsafe proximity. A tactile-predictive validator estimates contact-level risks including slip, deformation, pressure concentration, unstable contact transition, or fracture likelihood for contact-rich actions. Based on the predicted consequences, the system selectively releases, modifies, delays, decomposes, reroutes, stages, or rejects the candidate action. Validation may adapt to action risk, contact sensitivity, and operational context, and may be performed cooperatively across multiple physical artificial intelligence systems. Validation outcomes and execution results may be logged to improve later action generation, validation, and execution.

### FIELD OF THE INVENTION

The present disclosure relates generally to computers and physical artificial intelligence, and more specifically, to intercepting candidate actions generated by decision models and selectively validating such actions, before physical execution by actuators.

### BACKGROUND

Modern physical AI systems increasingly rely on learned policies, vision-language-action models (VLA), language-guided planners, reinforcement learning policies, diffusion policies, and other generative or predictive controllers to generate actions for robots, vehicles, drones, industrial machines, and other embodied systems.

Although such models can generate capable actions, real-world deployment raises substantial safety and reliability challenges. A learned model may generate an action that appears plausible from visual context but, when physically executed, leads to collision, instability, dropped objects, unsafe force, shattered objects, grip slip, unwanted deformation, or harm to nearby humans.

Conventional robot control systems often rely on low-level emergency stops, obstacle detection, static rule checkers, or offline testing. Such approaches are inadequate in many production settings because they frequently operate after unsafe motion has already begun or they lack sufficient insight into dynamic contact behavior.

A further bottleneck arises in dexterous manipulation. Many candidate actions are safe or unsafe not because of gross trajectory geometry, but because of fine tactile consequences, such as predicted micro-force concentration, surface compliance mismatch, object fracture risk, or incipient slip. Existing validation systems do not adequately use tactile-forward prediction before motor release.

Accordingly, there exists a need for a predictive actuation gate that interposes model-based validation between action generation and physical execution, and that can selectively apply tactile-informed validation for grasping, contact-rich manipulation, tool use, and other high-consequence actions.

### SUMMARY

The present disclosure provides systems and methods for predictive actuation gating prior to physical execution in physical AI systems.

In a first embodiment, a candidate action generated by one or more decision models is intercepted before motor release and evaluated using one or more forward-looking evaluators including a world model, physics simulator, learned dynamics model, digital twin, collision predictor, balance predictor, or force predictor.

In a second embodiment, the system determines whether the candidate action satisfies one or more validation criteria such as collision avoidance, balance preservation, geofence compliance, tool compatibility, object retention, human-safety margin, or confidence thresholds, and either releases, modifies, delays, decomposes, reroutes, or rejects the action.

In a third embodiment, a learned tactile-predictive validator receives the candidate action together with tactile context, force-torque data, contact history, object descriptors, or surface descriptors and predicts pre-execution tactile consequences including grip slip, contact-force distribution, surface deformation, object fracture likelihood, or unstable contact transitions.

In a fourth embodiment, tactile-informed validation is selectively invoked for high-risk manipulation actions such as grasping fragile objects, handling deformable items, high-force tool use, insertion tasks, or multi-finger dexterous maneuvers, while lower-risk actions may use lighter-weight validators.

In a fifth embodiment, the system logs validation outcomes and downstream real-world consequences to improve both the action generator and the predictive validators, including the tactile-forward model.

Many other variations are possible.

### BRIEF DESCRIPTION OF THE DRAWINGS

The present disclosure will be understood more fully from the detailed description given below and from the accompanying drawings of various embodiments of the disclosure.

FIG. 1A is a perspective diagram illustrating a humanoid robot as an example of a physical AI system that utilizes predictive actuation validation, in real world actions, according to an embodiment.

FIG. 1B is a perspective diagram illustrating multiple humanoid robots interacting with each other utilizing predictive actuation validation, in real world actions, according to an embodiment.

FIG. 2 is a more detailed block diagram illustrating internal components of a predictive action validator for intercepting command actions for validation, according to an embodiment.

FIG. 3 is a more detailed block diagram illustrating a physical AI platform (e.g., humanoid robot, drone, autonomous vehicle), according to an embodiment.

FIG. 4 is a sequence diagram illustrating a command action pipeline of interactions between the internal components of both the predictive action validator and the physical AI platform, according to an embodiment.

FIG. 5 is a flow diagram illustrating a method for predictive actuation validation, according to an embodiment.

FIG. 6 is a flow diagram illustrating a method for predictive actuation validation for swarm or cooperating physical AI systems, according to an embodiment.

FIG. 7 is a flow diagram illustrating a method for predictive actuation validation for independent physical AI systems, according to an embodiment.

FIG. 8 is a flow diagram illustrating a method for tactile-predictive validation, according to an embodiment.

FIG. 9 is a block diagram illustrating a computing environment for predictive action validation, according to an embodiment.

### DETAILED DESCRIPTION

The description below provides methods, computer program products, and systems in which candidate actions are intercepted before actuation and evaluated with predictive models. The present disclosure concerns the release decision that occurs between model-generated intent, based on real world scenarios, and motor execution, applied to the real world action.

A candidate action serves as an interface between decision-making and physical execution. By treating the action as a proposal subject to validation rather than as an immediately executable command, the system separates action generation from execution safety and reduces risk in real-world deployment.

Gating functions as a predictive control barrier that ensures only actions satisfying safety, feasibility, and task criteria are physically executed. By performing gating prior to motor release, the system shifts from reactive safety mechanisms, such as emergency stops, to proactive validation.

In some embodiments, the disclosed validation system operates with a vision-language-action (VLA) model, a local planner, a remote model, or a hybrid stack. In other embodiments, the disclosed systems operate with smaller deterministic controllers and selectively engage learned validation for higher-risk actions. In some embodiments, the physical AI platform is operated by one or more autonomous AI agents configured to perceive an environment, generate candidate actions, and cause physical execution responsive to task objectives. Autonomous physical AI can perceive and make inference-based responses.

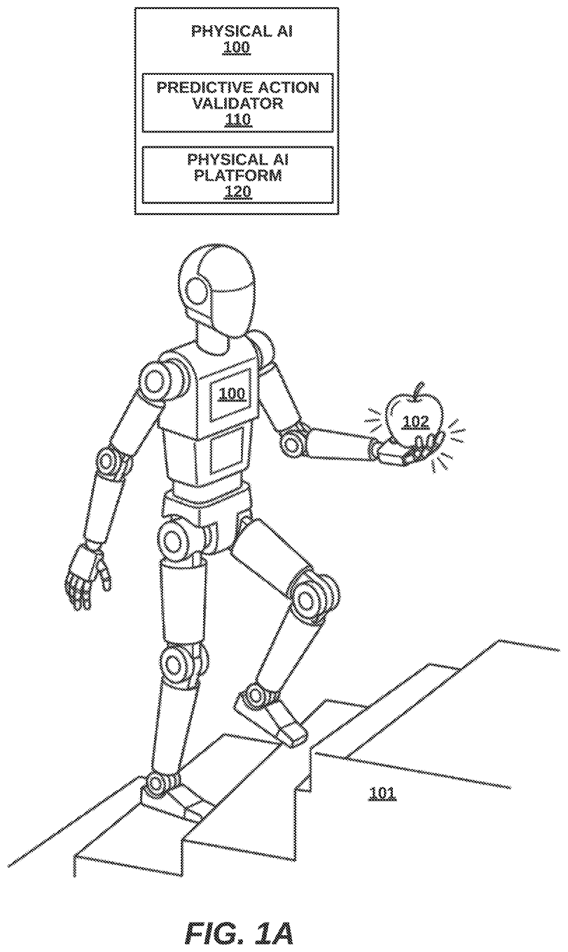

### I. Systems for Predictive Gating of Physical AI (FIGS. 1-4)

In FIG. 1A, a block diagram illustrates a physical AI system 100, in this case a humanoid robot, walking up a set of stairs 101, while gripping a delicate apple 102 as assisted by a predictive actuation validator 110, interoperating with a physical AI platform 120.

### A. Candidate Action

A candidate action comprises a machine-executable or machine-interpretable representation of a proposed physical behavior generated by one or more decision models for a physical artificial intelligence system. The candidate action is generated by the action generator 220 and is intercepted prior to motor release so that the candidate action can be evaluated before corresponding physical movement is carried out.

In particular, the candidate action represents a proposed act to be taken by the physical AI platform 120, but is treated as a provisional action proposal rather than an immediately executable motor command. This separation allows the action generator 220 to propose behavior based on task objectives while the predictive actuation validator 230 and, where applicable, the tactile-predictive validator 240 determine whether the action should be released, modified, staged, or blocked.

In some embodiments, the candidate action may be represented at different levels of abstraction. For example, the candidate action may comprise low-level actuator-oriented commands such as joint torques, joint velocities, joint position targets, wheel velocities, steering angles, thrust vectors, or motor current targets. In other embodiments, the candidate action may comprise higher-level task-space or behavior-level instructions, such as an end-effector pose, Cartesian trajectory, locomotion segment, grasp plan, insertion path, force profile, or sequence of sub-actions.

By way of example, for a robotic arm, a candidate action may specify moving an end effector to a pose above an object, descending along an approach vector, closing a gripper with a selected grip force, and lifting the object along an upward trajectory. For a mobile robot, a candidate action may specify turning, moving forward, or following a path segment. For a humanoid robot, a candidate action may specify shifting weight, extending an arm, and reaching for an object. For a drone, a candidate action may specify a change in heading, altitude, or thrust. For an autonomous vehicle, a candidate action may specify braking, steering correction, obstacle avoidance, or merging. These examples are illustrative only.

In some embodiments, the candidate action corresponds to a single control step. In other embodiments, the candidate action corresponds to a short-horizon motion segment, a manipulation primitive, or a longer-horizon multi-step plan. In some cases, longer-horizon candidate actions are decomposed into smaller portions that can be incrementally validated before execution. In some embodiments, the candidate action includes both kinematic and dynamic content, such as target pose, speed, force envelope, stiffness setting, grasp points, closure timing, gait parameters, footholds, or turning radius.

In some embodiments, the candidate action is accompanied by metadata or contextual attributes that assist validation. Such metadata may include a confidence score, model uncertainty value, predicted task outcome, prediction horizon, semantic label, expected-contact indicator, fragility indicator, or preferred operating constraint such as speed limit, clearance margin, or force ceiling. For example, a candidate action directed to grasping a fragile object may include metadata indicating expected contact and object fragility, thereby causing tactile-forward validation to be invoked.

In some embodiments, multiple candidate actions are produced and ranked according to score, utility estimate, likelihood, or policy confidence. The predictive actuation validator 230 may evaluate one or more of these candidate actions and select, authorize, or modify a preferred option. In some embodiments, multiple candidate actions are evaluated sequentially. In other embodiments, multiple candidate actions are evaluated in parallel.

Candidate action gating refers to a controlled pre-execution decision process by which a candidate action is selectively released, modified, delayed, decomposed, rerouted, or rejected based on one or more predicted consequences of carrying out that candidate action. In the disclosed system, gating is performed before motor release so that a proposed action is evaluated as a candidate for execution rather than being passed directly to the actuators.

### B. Physical Actuation Validation

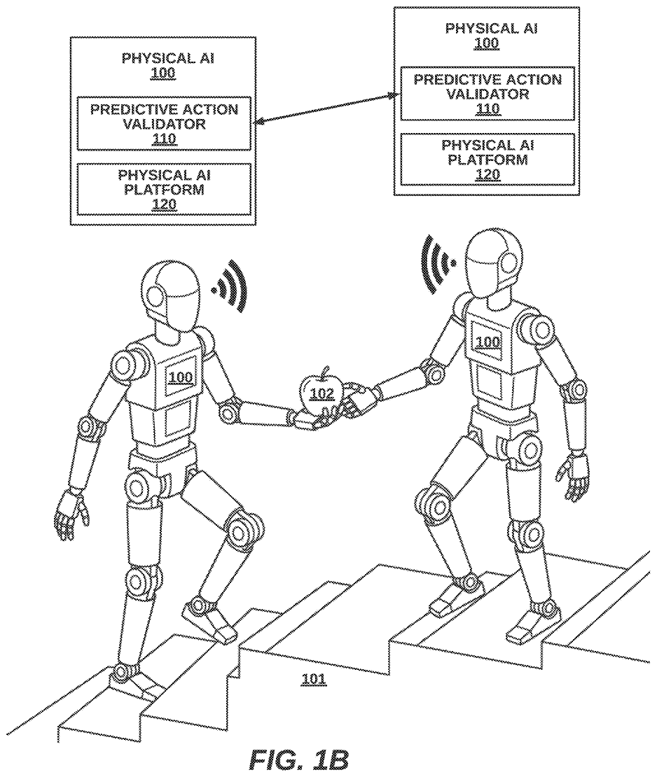

In FIG. 2, the physical actuation validator 110 is shown to include a perception module 210, an action generator 220, a predictive actuation validator 230, a tactile-predictive validator 240, and an actuator controller 250, according to an embodiment. The predictive actuation validator 230 is positioned logically between the action generator 220 and the actuator controller 250 so that a candidate action can be evaluated before motor release occurs.

The predictive actuation validator 230 comprises one or more modules configured to predict one or more likely physical consequences of executing a candidate action and to determine, based on such predicted consequences, whether the candidate action should be released, modified, delayed, decomposed, rerouted, or rejected. In this manner, the predictive actuation validator 230 functions as a forward-looking safety and feasibility layer that interposes predictive analysis between machine-generated intent and real-world actuation. Stated differently, the predictive actuation validator 230 attempts to determine what is likely to happen in the physical world if the candidate action is actually carried out, thereby preventing unsafe, unstable, or otherwise undesirable actions before physical execution begins.

In some embodiments, the predictive actuation validator 230 receives a variety of inputs for performing predictive evaluation. Such inputs may include the candidate action representation, outputs of the perception module 210, current robot or machine state, contact-state information, object-state information, environmental context, task constraints, and uncertainty information. In some embodiments, the predictive actuation validator 230 also receives semantic or symbolic constraints, such as geofence rules, tool-use restrictions, safety margins, mission rules, or task-completion conditions. The predictive actuation validator 230 may evaluate consequences over a selected prediction horizon that varies depending on action type, velocity, uncertainty, human proximity, object fragility, or operating mode.

In some embodiments, the predictive actuation validator 230 employs one or more forward-looking evaluators to estimate likely results of executing the candidate action. Such evaluators may include a learned world model, a learned dynamics model, a physics simulator, a collision predictor, a balance or stability predictor, a force or load predictor, a motion predictor for nearby humans or other agents, a grasp-retention predictor, a scene-occupancy predictor, and/or a rule-based or symbolic constraint engine. In some embodiments, these evaluators are used individually, and in other embodiments multiple evaluators are used in combination. Thus, the predictive actuation validator 230 may consider not only whether an action is theoretically possible, but whether it is acceptable under current physical and contextual conditions.

In some embodiments, the predictive actuation validator 230 produces a validation output or release decision indicating how the candidate action is to be handled. For example, the predictive actuation validator 230 may authorize release of the candidate action, reject the candidate action, modify the candidate action, delay or stage execution, decompose the candidate action into smaller sub-actions, reroute execution to an alternative controller or conservative mode, or trigger replanning by the action generator 220. In some embodiments, the validation output may comprise a binary decision. In other embodiments, the validation output may include a risk score, confidence metric, constraint set, modified action representation, failure-mode indication, commands to another process, or an explanation of why release was denied.

In some embodiments, the predictive actuation validator 230 operates in a risk-aware manner and may invoke different evaluators, thresholds, or release pathways depending on action type, uncertainty, contact sensitivity, or environmental context. In some embodiments, the predictive actuation validator 230 further cooperates with the tactile-predictive validator 240 for contact-rich actions and may perform validation before execution, during staged execution, or iteratively during execution. In some embodiments, a first predictive validator evaluates macro-scale physical consequences of a candidate action, and a second tactile-predictive validator is selectively invoked for contact-sensitive actions, wherein a release decision is generated based on outputs of both validators. Validation outcomes may also be logged and used for refinement of release criteria, predictive models, and future action proposals.

### C. Swarm and Distributed Physical Actuation Validation

As shown in FIG. 1B, a cooperative multi-agent physical actuation validation mode can be implemented in which a candidate action is validated, not only with respect to the local physical AI platform 120, but also with respect to one or more other physical artificial intelligence systems, nearby robots, remote robots, or a swarm of physical AI systems. In this manner, the predictive actuation validator 230 may determine whether a candidate action remains safe, feasible, and task-consistent when the action is part of a coordinated multi-machine activity rather than an isolated machine behavior. The other systems can be working cooperatively under a common workflow. By contrast, the other system can be working independently, having diverging or even competing workflows.

More specifically, a candidate action proposed for one physical AI system may depend on, interfere with, or be improved by the actions of one or more other physical AI systems. Accordingly, the disclosed validation architecture may evaluate not only single-agent physical consequences, but also cooperative or cross-agent physical consequences such as timing conflicts, shared-object instability, line-of-travel interference, tool handoff mismatch, concurrent force application, sequencing errors, or unsafe proximity between independently actuated machines.

In some embodiments, the disclosed system operates with a centralized action generator layer configured to receive state information from a plurality of physical AI systems and to generate, allocate, coordinate, or sequence candidate actions across a swarm or distributed set of physical AI platforms. The centralized action generator layer may operate on a local device, an edge server, a factory controller, a supervisory robot controller, or a cloud-based computing environment. Communications between the centralized action generator layer and participating physical AI systems may occur over Wi-Fi, wired industrial communication channels, private wireless infrastructure, cellular links, cloud-mediated communication paths, or combinations thereof.

In some embodiments, the centralized action generator layer maintains a shared task model, shared environment model, or shared operational policy for a plurality of robots or physical AI systems. For example, in a manufacturing environment, the centralized layer may allocate tasks among robotic arms, conveyors, AMRs, inspection robots, packaging robots, or tool-bearing systems. In other embodiments, the centralized layer coordinates warehouse, logistics, or other multi-system deployments so that candidate actions for one system are validated in view of expected movement and timing of others.

In some embodiments, the swarm or cooperating set of physical AI systems need not be physically or temporally co-located. For example, physically separated robots at different facilities may encounter substantially similar handling, insertion, gripping, or line-operation scenarios. The centralized action generator layer and/or associated predictive actuation validation policy may cause such systems to evaluate and respond to such common scenarios using a shared validation technique, shared release policy, shared risk thresholds, shared learned model, or shared task-handling template. In this manner, the disclosed architecture may provide cross-site consistency in predictive actuation gating even where the physical AI systems are separated by large distance.

In some embodiments, cooperative physical actuation validation includes evaluation of shared-object operations, cooperative force application, staged handoffs, synchronized motion, mutually exclusive workspaces, peer-readiness conditions, or line-sequencing dependencies. Thus, release of a candidate action may depend not only on local prediction, but also on one or more peer-system states, peer candidate actions, or distributed validation inputs.

Accordingly, swarm and distributed physical actuation validation extend predictive gating beyond a single machine so that candidate actions are evaluated in view of nearby peers, remote peers, centralized coordination, and shared operating policies. By accounting for cross-agent and cross-site consequences, the disclosed system improves safety, consistency, and task success in cooperative physical AI deployments.

### D. Tactile-Predictive Validation

The tactile-predictive validator 240 comprises one or more modules configured to predict likely tactile consequences of executing a candidate manipulation action before full physical execution occurs, and to use such predicted tactile consequences in determining whether the candidate manipulation action should be released, modified, delayed, staged, or rejected. In this manner, the tactile-predictive validator 240 provides a fine-grained validation layer focused on contact behavior, grip quality, surface interaction, and other micro-scale physical effects that may not be adequately captured by macro-scale motion, collision, or balance prediction alone.

In one embodiment, a candidate manipulation action may correspond to a grasp action, insertion action, contact-rich tool-use action, deformable-object handling action, multi-finger dexterous manipulation action, or another action likely to involve tactile-sensitive interaction. The tactile-predictive validator 240 may receive tactile-related input data associated with the candidate manipulation action, including tactile sensor data, force-torque data, contact geometry, object descriptors, surface descriptors, end-effector state, gripper state, contact history, environmental context, compliance estimates, friction estimates, or contamination-related information.

In some embodiments, the candidate manipulation action and tactile-related input data are provided to a tactile-predictive model before full physical execution. In some embodiments, the tactile-predictive model comprises a learned tactile-forward model configured to predict future tactile states or contact-related consequences associated with the candidate manipulation action. Such tactile consequences may include slip probability, contact-force distribution, tangential force imbalance, normal-force distribution, local pressure concentration, deformation magnitude, unstable contact transition, fracture likelihood, indentation depth, or force escalation trajectory.

In some embodiments, the tactile-predictive validator 240 evaluates the candidate manipulation action against one or more tactile validation criteria, such as maintaining grip stability above a threshold, avoiding predicted slip, limiting pressure concentration below a damage threshold, maintaining deformation within an allowable range, preserving object integrity, or avoiding fracture, tearing, crushing, or irreversible deformation. Based on the one or more predicted tactile consequences, the tactile-predictive validator 240 may selectively release, modify, delay, stage, or reject the candidate manipulation action. In various embodiments, modification may include changing grip force, contact point, finger spacing, closure speed, compliance setting, force ramp profile, or approach orientation.

In some embodiments, the tactile-predictive validator 240 operates in coordination with the predictive actuation validator 230. For example, the tactile-predictive validator 240 may provide a tactile-risk score, a tactile constraint set, a modification recommendation, or a veto decision that is used by the predictive actuation validator 230 in reaching a final release decision. In other embodiments, the tactile-predictive validator 240 may independently block the candidate manipulation action before the candidate manipulation action reaches the actuator controller 250.

In some embodiments, the candidate manipulation action is staged so that only an initial contact phase or partial closure phase is released, after which additional tactile prediction is performed using newly obtained tactile information before further execution is authorized. In some embodiments, tactile-predictive validation is selectively invoked for grasping fragile objects, handling deformable objects, performing insertion operations, using tools, executing multi-finger dexterous manipulation, or performing contact-rich manufacturing operations, while non-contact actions may bypass tactile prediction or use a lower-weight tactile validation path.

In some embodiments, the system logs predicted tactile outcomes, measured tactile outcomes, validation decisions, modification decisions, and contact failures for later training and refinement of one or more tactile-forward models, tactile thresholds, or action-generation strategies. Feedback from the tactile-predictive validator 240 may also be provided to the action generator 220 so that later candidate actions may be proposed with more suitable grasp points, force levels, insertion angles, or contact strategies.

Accordingly, tactile-predictive validation provides a predictive contact-validation layer that forecasts likely tactile and contact consequences before full motor release. By using tactile-forward prediction in combination with predictive actuation validation, the disclosed system improves the safety and reliability of grasping, insertion, tool use, deformable-object handling, and other contact-rich operations.

### E. Candidate Action Pipeline

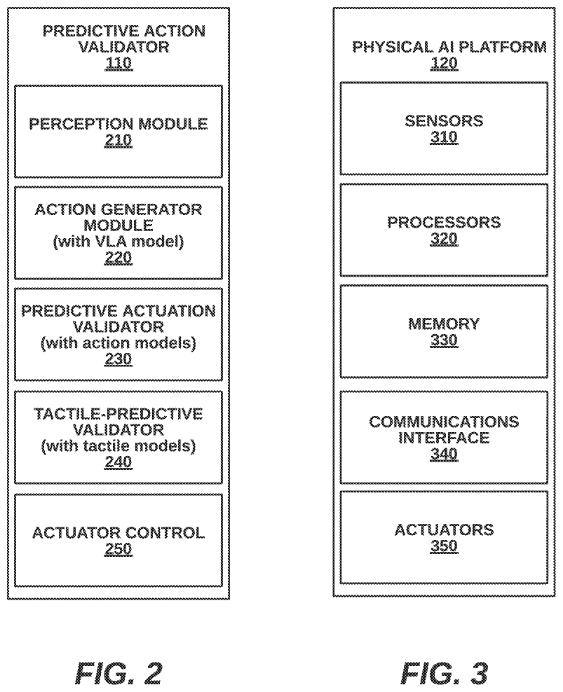

In FIG. 3, the physical AI platform 120 is shown to include one or more sensors 310, one or more processors 320, memory 330, communications interfaces 340, and one or more actuators 350. In the traditional physical AI pipeline, sensor-derived information is processed by a perception module 210, provided to an action generator 220, and then translated by an actuator controller 250 into executable motor control for the actuators 350.

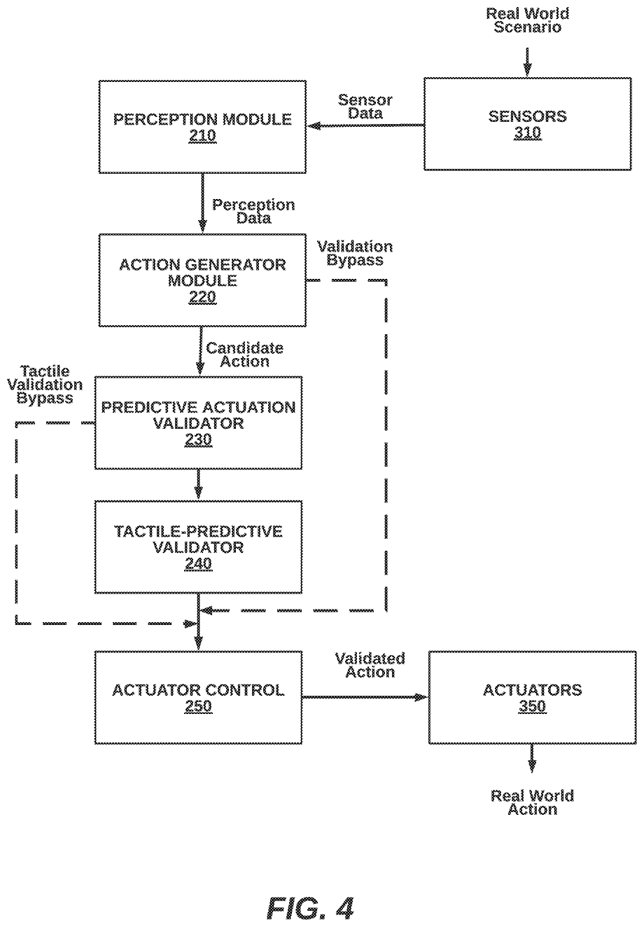

In the disclosed architecture, however, the traditional pipeline between real world scenario and real world action by physical AI 100 is intercepted before release to the actuator controller 250. In FIG. 4, a data path is illustrated depicting message paths or lines between the pipeline components, showing example inputs and outputs exchanged among: the perception module 210, action generator 220, predictive actuation validator 230, tactile-predictive validator 240, actuator controller 250, and physical AI platform 120. More specifically, a candidate action output by the action generator 220 is intercepted by a predictive actuation validator 230 and, when applicable, a tactile-predictive validator 240, so that one or more validation policies are applied before the candidate action is released for physical execution. Thus, the pipeline may be understood as a candidate-action pipeline in which perception outputs, state information, and task context flow into the action generator 220; the action generator 220 outputs one or more candidate actions; the candidate actions are selectively intercepted, evaluated, modified, delayed, decomposed, rerouted, staged, or rejected by the validators 230 and 240; and only an authorized action is then released to the actuator controller 250 for actuation.

The perception module 210 receives sensor-derived input (e.g., one or more of voice, text, images) from the physical AI platform 120, including one or more outputs of the sensors 310, and generates structured perception output for downstream use in the candidate-action pipeline. In various embodiments, the perception output may include one or more of scene information, object information, state information, obstacle information, contact estimates, human-presence information, confidence values, uncertainty values, semantic context, or task-relevant environmental descriptors. The perception module 210 therefore serves as an upstream information stage that converts raw or partially processed sensory data into machine-interpretable input for candidate-action generation and for subsequent validation. Such perception output is provided to the action generator 220 and, in some embodiments, may also be supplied to the predictive actuation validator 230 and the tactile-predictive validator 240 as part of the validation input set.

The action generator 220 receives the perception output and produces one or more candidate actions for the physical AI platform 120. In some embodiments, the action generator 220 may also receive one or more of task objectives, natural-language instructions, memory state, mission rules, prior execution history, or machine-state information. The output of the action generator 220 is a candidate action representation, which may correspond to a low-level control proposal, a task-space motion proposal, a manipulation primitive, a locomotion segment, a contact strategy, or a multi-step action sequence. In some embodiments, the action generator 220 produces multiple candidate actions or ranked alternatives. Rather than being transmitted directly to the actuator controller 250, the candidate action output of the action generator 220 is intercepted by the predictive actuation validator 230 so that the action remains a provisional action proposal subject to pre-release validation. In some embodiments, the physical AI 100 is designed for validation, while in other embodiments, an operating system (OS) update and/or application download adds validation to a conventional deployment.

The predictive actuation validator 230 receives the candidate action from the action generator 220 and applies one or more validation policies before motor release occurs. In some embodiments, the predictive actuation validator 230 also receives one or more additional inputs including perception output from the perception module 210, machine-state information, environmental context, contact-state information, object-state information, task constraints, and uncertainty information. Using such inputs, the predictive actuation validator 230 predicts one or more macro-scale physical consequences associated with execution of the candidate action, such as collision risk, instability risk, force-limit violation, geofence violation, loss of object retention, unsafe human proximity, tool incompatibility, or task-failure likelihood. Based on one or more applicable validation policies, the predictive actuation validator 230 may generate one or more outputs including a release authorization, a denial decision, a risk score, a modified candidate action, a staged-release instruction, a decomposition instruction, a rerouting instruction, or a request for replanning. In some embodiments, the predictive actuation validator 230 further determines whether the candidate action is associated with a contact-sensitive condition and, responsive thereto, selectively invokes the tactile-predictive validator 240.

The tactile-predictive validator 240 receives the candidate action, or one or more contact-relevant portions thereof, together with one or more tactile-related inputs and applies tactile-oriented validation policies before release to the actuator controller 250. In various embodiments, such tactile-related inputs may include tactile sensor data, force-torque information, contact history, object descriptors, surface descriptors, gripper or end-effector state, predicted contact location, friction information, compliance information, or other contact-sensitive context. The tactile-predictive validator 240 predicts one or more tactile consequences of executing the candidate action, such as slip probability, contact-force distribution, local pressure concentration, unstable contact transition, deformation magnitude, or fracture likelihood. The tactile-predictive validator 240 may output one or more of a tactile-risk score, a tactile constraint set, a tactile modification recommendation, a staged-contact recommendation, or a tactile veto. In some embodiments, the final release decision is generated by the predictive actuation validator 230 policies based on both macro-scale and tactile-scale validation outputs, while in other embodiments the tactile-predictive validator 240 policies may independently block release of the candidate action.

The actuator controller 250 receives only an authorized action after the validation stages have completed and release has been permitted. In some embodiments, the input to the actuator controller 250 may include the originally proposed candidate action, a modified action, a decomposed action segment, a staged-release action, or an action accompanied by one or more execution constraints such as force limits, speed limits, clearance limits, geofence limits, or contact-related constraints. The actuator controller 250 converts the released action into executable control signals for the actuators 350 and may also generate execution feedback, such as measured force, contact-state changes, trajectory deviations, slip events, or other execution-state information. In some embodiments, such execution feedback is returned upstream for logging, refinement, revalidation, or future action-generation improvement. Accordingly, the actuator controller 250 serves as the downstream execution stage of the candidate-action pipeline, but only after the intercepted candidate action has passed through the validation stages imposed by the predictive actuation validator 230 and, where invoked, the tactile-predictive validator 240.

A validated action is compared against an original candidate action, in some cases. This final step can check for hallucinations, apply more abstract physical AI policies, or even run against a small language model (SLM) trained to local, special, user input, or recent conditions for additional adjustments or gating.

### F. Candidate Action Validation Policy

The disclosed system may apply a gating and candidate action validation policy to determine how much predictive evaluation, which validation resources, and what release criteria should be applied to a given candidate action before motor release. In this manner, the system need not treat all candidate actions identically. Rather, the policy may adapt to predicted consequence, uncertainty, contact sensitivity, operational context, and task significance associated with the candidate action.

Stated differently, the gating and candidate action validation policy determines what level of scrutiny a proposed action should receive, which validators should be invoked, and whether the candidate action should be released, modified, delayed, staged, decomposed, rerouted, or rejected before physical execution. A simple free-space movement under stable conditions may receive a lightweight validation pass, while a higher-risk, contact-rich, cooperative, or uncertain action may trigger more extensive predictive analysis, including tactile-forward prediction, multi-stage gating, staged execution, or cooperative validation.

In some embodiments, the system classifies a candidate action according to one or more risk-related categories, such as contact versus non-contact, high-force versus low-force, human-adjacent versus human-remote, fragile-object manipulation versus durable-object manipulation, familiar versus novel behavior, high-uncertainty versus high-confidence perception, simple motion versus complex multi-step interaction, and/or single-agent versus cooperative multi-agent execution. In some embodiments, multiple such categories are combined into a composite risk score, policy label, or decision tier used to determine how the candidate action is processed.

For example, a candidate action corresponding to free-space arm movement in an uncluttered environment may be classified as low-risk and evaluated using a lightweight collision and feasibility check. By contrast, a candidate action directed to grasping a fragile object, performing an insertion task, manipulating a deformable package, or moving near a human operator may be classified as higher-risk and may therefore require a more detailed predictive rollout, tighter release thresholds, staged actuation, and/or tactile-predictive validation.

In some embodiments, the policy determines whether one or more specialized validators should be invoked. For example, a low-risk candidate action may be evaluated only by a lightweight instance of the predictive actuation validator 230, whereas a higher-risk candidate action may invoke one or more higher-fidelity world models, dynamics predictors, physics simulations, or digital-twin resources. A contact-rich action may additionally invoke the tactile-predictive validator 240 so that contact-level risks such as slip, fracture, deformation, or pressure concentration are considered before release.

In some embodiments, the policy further specifies the manner of gating and release. For example, a candidate action may be released in full, released progressively, delayed pending additional sensing, modified prior to release, decomposed into smaller validated portions, rerouted to a fallback controller, or rejected outright. In some embodiments, the policy may also impose conservative operating limits such as reduced speed, reduced force, narrower geofence boundaries, increased clearance requirements, communication-confirmation requirements, or peer-readiness conditions before execution continues.

In some embodiments, when validation indicates that a candidate action does not satisfy the applicable policy, the system may take one or more responsive measures. For example, the system may block the candidate action, modify the candidate action by lowering speed, lowering grip force, changing approach angle, increasing clearance, reducing force ramp, requesting replanning from the action generator 220, decomposing the action into smaller validated sub-actions, rerouting execution to a fallback controller, or entering a degraded safe mode or protected operating mode.

In some embodiments, the gating and candidate action validation policy is itself adaptive. For example, thresholds, classification criteria, validator-selection rules, release conditions, and escalation rules may be adjusted based on historical outcomes, environmental conditions, task history, object class, operator preference, deployment mode, or cross-site operational experience. A system operating in a factory setting may apply different release criteria than a consumer robot operating in a home with higher uncertainty and more human interaction.

Accordingly, the gating and candidate action validation policy serves as a policy-level control framework governing how candidate actions are classified, evaluated, and released. By adapting validation burden and release conditions to predicted risk, physical context, and operational scenario, the disclosed system improves safety, task success, and operational efficiency without requiring uniform heavy-weight validation for every proposed action.

### G. Training and Continuous Improvement

In some embodiments, the disclosed system supports training and continuous improvement based on validation outcomes, execution outcomes, sensed physical consequences, and downstream real-world results. Thus, the system is not limited to fixed models or fixed release policies, but may improve over time as additional candidate actions are generated, validated, executed, modified, or rejected.

Stated differently, the disclosed architecture may learn not only from successful actions, but also from rejected actions, near-failure events, modified actions, tactile anomalies, force excursions, and mismatches between predicted and actual outcomes. This allows the system to improve future action generation, predictive validation, tactile prediction, risk classification, and release-threshold selection based on accumulated operational experience.

In some embodiments, the system logs information associated with each candidate action, including the candidate action representation, contextual metadata, perception outputs, environmental context, predicted physical and tactile consequences, risk scores, release decisions, constraint violations, sensed forces, tactile measurements, observed execution trajectories, and actual outcomes. In some embodiments, the system additionally stores indicators of why a candidate action was rejected or modified, such as predicted collision, inadequate balance margin, excessive deformation, likely slip, or excessive uncertainty.

For example, if a candidate action directed to grasping a fragile object is rejected because the tactile-predictive validator 240 predicts excessive pressure concentration, the system may store the proposed grasp geometry, grip-force profile, predicted pressure distribution, object class, and resulting rejection decision. If an approved locomotion maneuver later exhibits greater instability than predicted, the system may store the approved trajectory, predicted stability values, measured inertial data, and actual deviation during execution. If a candidate action is modified before release and then succeeds, the system may store both the original proposal and the successful modified version.

In some embodiments, logged data is used to improve one or more predictive or decision-making components, such as learned world models, learned dynamics models, tactile-forward models, collision predictors, force predictors, risk classifiers, threshold estimators, or action-generation policies. In some embodiments, such data may also be used to calibrate confidence values, improve uncertainty estimation, update validation criteria, or refine routing rules for local versus remote validation.

In some embodiments, the system distinguishes among approved actions, rejected actions, modified actions, and executed actions for training purposes. Rejected actions may provide examples of predicted unsafe behavior, modified actions may show how unacceptable proposals can be converted into acceptable ones, successful actions may provide examples of safe behavior, and approved but unsuccessful actions may reveal predictive mismatch.

In some embodiments, tactile and contact-rich interactions are logged with particular granularity, including tactile sensor traces, force-torque sequences, contact geometry, predicted slip values, measured slip onset, deformation estimates, fracture-related signals, and contact-timing information. Such data may be especially useful in improving tactile-forward models and refining validation criteria for fragile, compliant, slippery, or deformable objects.

In some embodiments, the system performs continuous improvement locally, remotely, or in a hybrid arrangement. For example, execution records may be logged locally during operation and periodically uploaded to a remote training service for batch model improvement. In other embodiments, online adaptation or partial local refinement may occur during deployment, such as updating calibration values, adjusting release thresholds, or refining object-specific handling parameters. In some embodiments, safety-critical release rules remain fixed while predictive models are updated over time.

In some embodiments, information gathered through training and continuous improvement is fed back to the action generator 220, predictive actuation validator 230, tactile-predictive validator 240, and actuator controller 250. For example, repeated rejection of a grasp pattern may cause the action generator 220 to avoid proposing that pattern, while repeated deviation between predicted and measured outcomes may cause the predictive actuation validator 230 to adjust its models or thresholds.

Accordingly, training and continuous improvement provide an experience-driven refinement layer for the disclosed architecture. By using logged validation decisions, predicted outcomes, tactile predictions, sensed consequences, and actual downstream results to improve future operation, the system becomes better able to generate, evaluate, and execute candidate actions in a safe, reliable, and context-sensitive manner over time.

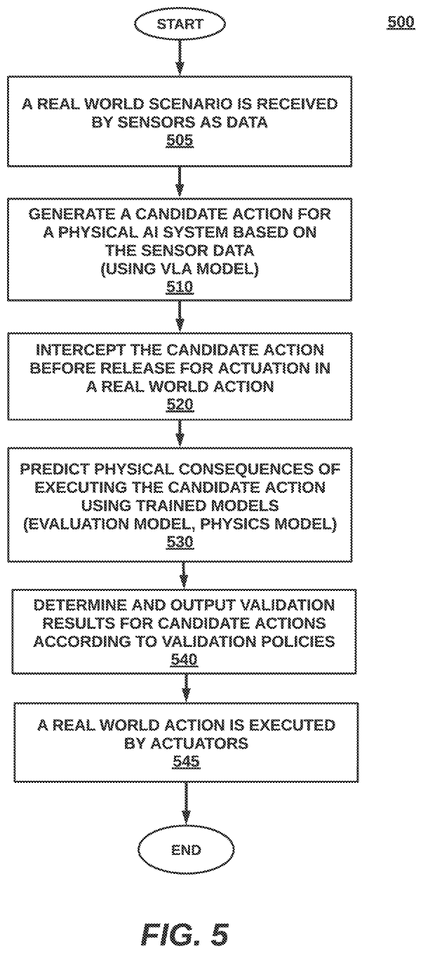

### II. Methods for Predictive Gating of Physical AI (FIGS. 5-8)

The disclosed systems may be implemented using one or more methods for intercepting, evaluating, coordinating, and selectively releasing candidate actions before physical execution. The order of steps may vary, and steps may be omitted, added, repeated, or combined in different embodiments.

### A. Method for Predictive Actuation Validation

FIG. 5 is a flow diagram illustrating a method 500 for using predictive actuation validation, while actuating real world actions as processed from real world scenarios, according to an embodiment.

In one embodiment, the method 500 begins when a real world scenario is input (505) in order to generate a candidate action for a physical artificial intelligence system (510). The candidate action may correspond to a control command, motion proposal, manipulation primitive, locomotion segment, or another proposed physical behavior.

The candidate action is intercepted before motor release (520). In some embodiments, the system also obtains validation inputs associated with the candidate action, including perception outputs, current machine state, object-state information, environmental context, task constraints, expected contact type, confidence information, uncertainty information, or semantic or symbolic rules.

The method may further include predicting one or more physical consequences of executing the candidate action using one or more forward-looking evaluators (530). Such evaluators may include a learned world model, learned dynamics model, physics simulator, collision predictor, balance predictor, force predictor, scene-occupancy predictor, grasp-retention predictor, or rule-based constraint engine. In some embodiments, the system also classifies the candidate action and determines whether one or more validation criteria are satisfied.

In response to the validation determination, the method may output validation results (540), including selectively releasing, modifying, delaying, decomposing, rerouting, or rejecting the candidate action. The output may also include a release decision, risk score, confidence metric, constraint set, modified action representation, or explanation for denial. Validated command actions employ actuators to take real world actions (545) on the real world scenario (505).

In some embodiments, after release, the method may further include feedback from monitoring downstream execution and logging candidate actions, predicted consequences, release decisions, sensed outcomes, and actual execution results for later refinement.

### B. Method for Predictive Actuation Validation of Cooperating Systems

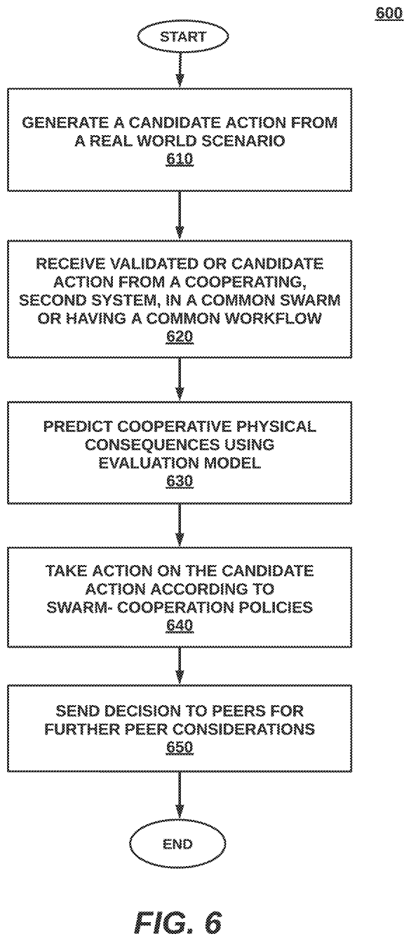

FIG. 6 is a flow diagram illustrating a method 600 for predictive actuation validation of coordinated workflows between systems, according to an embodiment.

In one embodiment, a candidate action is generated from a real world scenario of a first physical artificial intelligence system (610), and one or more peer actions that are candidate or validated actions are received from a second system (620). The peer action may be a candidate under consideration while swarm feedback is collected, or a validated action that on the other hand is definite as upcoming or already in progress. The first and second systems may be part of a swarm, fleet, coordinated manufacturing line, or other cooperative set of physical artificial intelligence systems, such as a group of humanoid robots. The first and second actions derive from a common workflow handled by autonomous systems or centrally controlled systems. The first and second systems can be proximate and in direct physical contact, such as a first humanoid robot handling off an apple to a second humanoid robot. Alternatively, the first and second systems can be spatially and/or temporally separated while still under a common workflow, such as a first humanoid robot storing an apple in a cabinet for later pickup by a second humanoid robot, or the first humanoid robot later repeating the same task as the second humanoid robot.

Cooperative physical consequences are predicted from potential execution of the candidate action in view of the one or more peer actions and common workflow (630). A swarm trained model is specifically trained for multi-system interactions or a peer role within swarms. Such cooperative physical consequences may include inter-robot collision risk, shared-object instability, force imbalance, timing conflict, workspace interference, handoff mismatch, fixture occupancy conflict, line sequencing error, or insufficient synchronization. In one example, two humanoid robots are lifting a box of apples having a weight that neither can handle alone.

A swarm policy governs action an action taken on the first, validating or gating actions (640). Optionally, the decision can be sent to the second system or the central coordinator for further considerations (650).

### C. Method for Predictive Actuation Validation of Independent Systems

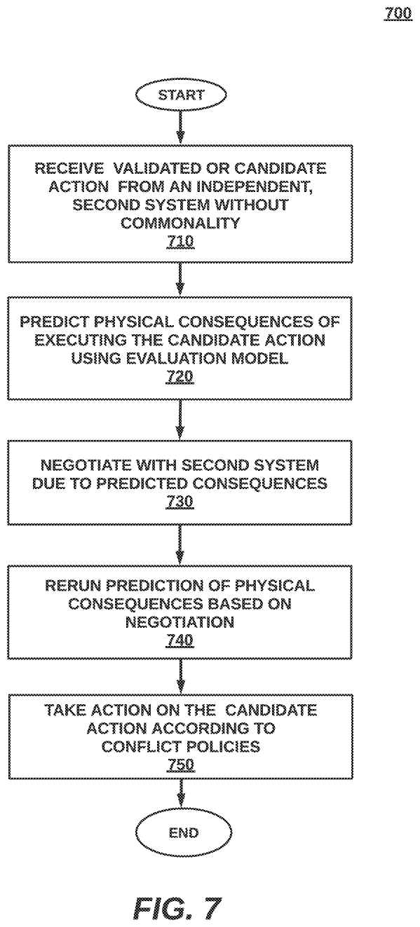

FIG. 7 is a flow diagram illustrating a method 700 for predictive actuation validation of independent systems, according to an embodiment. Relative to the common workflow systems of FIG. 6, the present systems may have diverging or competing interests.

A candidate action is received from a first physical artificial intelligence system, and one or more peer actions that are candidate or validated actions are received from a second system (710). The first and second systems may have a common interest, such as first and second humanoid robots handing off an apple, but for their own independent workflows. In another case, the first and second systems may have different interests, such as both wanting to retrieve the same apple at the same time.

Physical consequences are predicted from potential execution of the candidate action in view of the one or more peer actions (720). Due to potential consequences and lack of common interest, a negotiation process is initiated in which the first candidate action is communicated to the second system and feedback is returned including a modified peer action (730). The prediction model can be rerun with updated physical consequences used for a final validated or gating action (740), which also may be communicated to the second system as follow up. Some implementations use iterative negotiations over several rounds of back-and-forth. An action is taken on the candidate according to, for instance, conflict policies (750).

### D. Method for Tactile-Predictive Validation

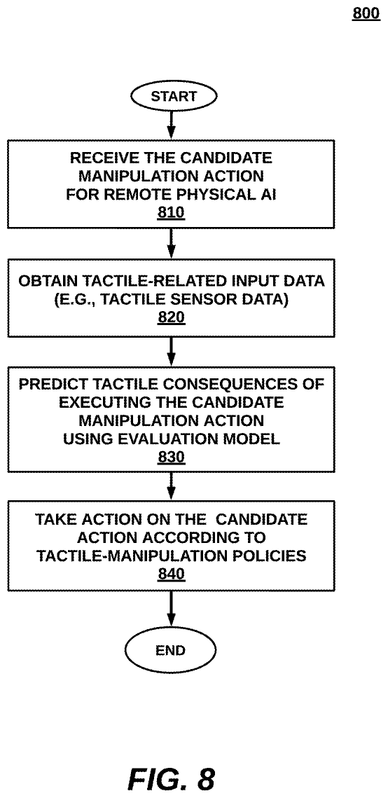

FIG. 8 is a flow diagram illustrating a method 800 for tactile-predictive validation, according to an embodiment.

A candidate manipulation action concerning an interaction with an object in the real world is received by a physical artificial intelligence system (810). The candidate manipulation action may correspond to a grasp action, insertion action, contact-rich tool-use action, deformable-object handling action, multi-finger dexterous manipulation action, or another tactile-sensitive action. Further details can include how high an object will be lifted, how far an object will be transported, and what position the object should be oriented (e.g., a glass or water).

Tactile-related input data associated with the candidate manipulation action is obtained (820). Such tactile-related input data may come from sensors including tactile sensor data, force-torque data, contact geometry, object descriptors, surface descriptors, end-effector state, gripper state, contact history, environmental context, compliance estimates, friction estimates, or contamination-related information. For instance, an apple being picked up or transported can be weighed, a size can be estimated, a pose or position can be determined, and a surface condition can be identified.

Tactile consequences are then predicted from the potential execution of the candidate manipulation action (830). In some embodiments, the tactile-predictive model comprises a learned tactile-forward model configured to predict future tactile states or contact-related consequences. The model can be trained with previous experience from the device or from others in a swarm of devices, YouTube video, physics tables, and the like. Such tactile consequences may include slip probability, contact-force distribution, pressure concentration, deformation magnitude, unstable contact transition, fracture likelihood, indentation depth, or force escalation trajectory.

The candidate manipulation action is evaluated against one or more tactile validation criteria from a tactile validation policy (830), in some implementations. In other words, the potential risks are compared against predetermined risk tolerances, such as a low tolerance for a wet breakable dish and a high tolerance for a rubber ball or object with a handle. Additional considerations can include maintaining grip stability, avoiding predicted slip, limiting pressure concentration, maintaining deformation within an allowable range, preserving object integrity, or avoiding fracture, tearing, crushing, or irreversible deformation.

An action is taken from the predictions including validating or gating the candidate manipulation action (840). In some embodiments, modification may include changing grip force, contact point, finger spacing, closure speed, compliance setting, force ramp profile, or approach orientation.

Accordingly, the methods illustrated in FIGS. 5-8 provide multiple procedural implementations of the disclosed architecture, including predictive actuation validation for individual systems, swarm-based cooperative validation, distributed cross-system validation, and tactile-predictive validation for contact-rich actions. These methods may be used individually or in combination, depending on the physical AI deployment, operational context, and desired validation rigor.

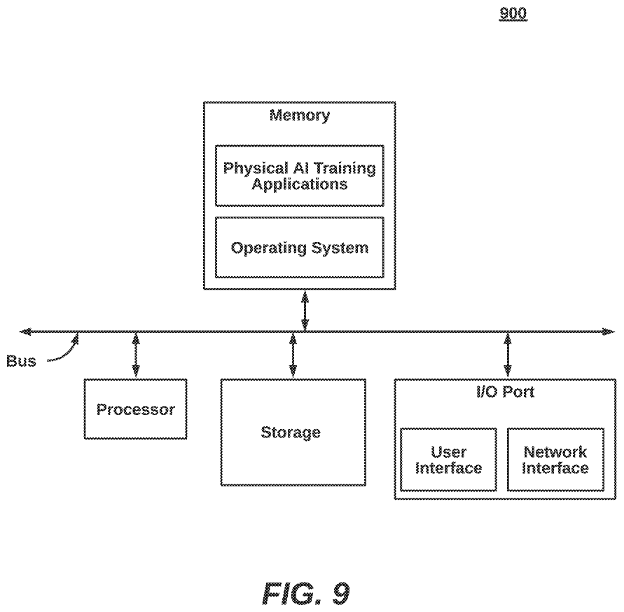

### III. Computing Environment for Predictive Gating of Physical AI (FIG. 9)

In FIG. 9, a computing environment 900 implementable by various components of FIGS. 1A and B includes a memory storing network applications and an OS, a processor, a storage drive, and an I/O port including a user interface and a network interface, coupled by a bus. The processor executes instructions to perform the operations described herein and may comprise a CPU, GPU, NPU, or an array of interconnected processors. In some embodiments, the computing environment includes AI-optimized hardware, such as cooperating CPUs and GPUs or other hardware accelerators, for local SLM execution and edge inferencing.

The disclosed operations may be implemented as computer-executable instructions stored on a non-transitory computer-readable medium and executed within a software environment managed by an operating system. The operating system may comprise a conventional operating system or an agent-oriented operating system. In some embodiments, the environment further includes structural security sandboxes, isolated execution runtimes, AI agents, automation tools, autonomous agent frameworks, local SLMs, remote LLMs, and associated inference engines.

The computing environment may communicate over a network including a LAN, WAN, cellular network, Wi-Fi network, or the Internet. In the context of the present disclosure, the network serves as a conduit for transmission of prompts, tool outputs, model responses, and other data between local devices, remote validators, centralized coordination systems, and external model providers.

This description has been presented for purposes of illustration and description and is not intended to be exhaustive or limiting. Many modifications and variations will be apparent to one of ordinary skill in the art. The scope of the invention is defined by the following claims.

1-20. (canceled)

21. A computer-implemented method for predictive actuation gating in a physical artificial intelligence system, comprising:
receiving a candidate action generated for the physical artificial intelligence system;
intercepting the candidate action before motor release to one or more actuators of the physical artificial intelligence system;
obtaining validation inputs associated with the candidate action, the validation inputs comprising a representation of the candidate action and one or more of perception output, a current state of the physical artificial intelligence system, environmental context, task constraints, or uncertainty information;
determining, under a candidate action validation policy and based on the validation inputs, a validation burden and one or more release criteria for the candidate action;
selecting, based on the validation burden, one or more predictive validators from a plurality of predictive validators having different physical-consequence evaluation capabilities;
predicting, by the selected one or more predictive validators, one or more physical consequences of executing the candidate action;
determining whether the predicted one or more physical consequences satisfy the one or more release criteria; and
generating, before the motor release, an execution directive that selectively releases, modifies, limits, delays, decomposes, reroutes, or rejects the candidate action based on the determining.

22. The method of claim 21, wherein the one or more physical consequences comprise one or more of collision risk, instability risk, force-limit violation, loss of object retention, unsafe proximity to a human, geofence violation, tool incompatibility, or task-failure likelihood.

23. The method of claim 21, wherein the plurality of predictive validators comprises two or more of a learned world model, a learned dynamics model, a physics simulator, a digital twin, a collision predictor, a balance or stability predictor, a force or load predictor, a motion predictor for a human or another agent, a scene-occupancy predictor, a grasp-retention predictor, or a rule-based or symbolic constraint engine.

24. The method of claim 21, wherein determining the validation burden comprises classifying the candidate action according to two or more of action type, velocity, force, uncertainty, human proximity, object state, environmental context, task significance, operating mode, or consequence severity.

25. The method of claim 21, wherein selecting the one or more predictive validators comprises selecting a lightweight validator for a first validation burden and selecting a higher-fidelity world model, dynamics predictor, physics simulation, or digital-twin resource for a second validation burden greater than the first validation burden.

26. The method of claim 21, wherein the validation inputs include uncertainty information, and wherein the execution directive reroutes the candidate action to a fallback controller or causes entry into a degraded safe mode when the predicted one or more physical consequences do not satisfy the one or more release criteria.

27. The method of claim 21, wherein the candidate-action validation policy selects a first prediction horizon for a first candidate action and a different second prediction horizon for a second candidate action based on one or more of action type, velocity, uncertainty, human proximity, object state, or operating mode.

28. The method of claim 21, wherein the one or more predictive validators comprise a plurality of selected predictive validators, and wherein generating the execution directive comprises resolving respective outputs of the plurality of selected predictive validators according to one or more applicable validation policies.

29. The method of claim 28, wherein resolving the respective outputs comprises applying a confidence value, risk score, constraint set, modification recommendation, failure indication, or applicable release criterion.

30. The method of claim 21, further comprising providing only an action authorized by the execution directive to an actuator controller that converts the authorized action into executable control signals for the one or more actuators.

31. A physical artificial intelligence system, comprising:
one or more actuators;
an action generator configured to generate a candidate action for physical execution by the one or more actuators;
a plurality of predictive validators having different validation burdens and configured to predict respective physical consequences of executing candidate actions;
a candidate-action validation policy defining validator-selection rules and release criteria; and
one or more processors configured to:
intercept the candidate action before release to the one or more actuators;
classify the candidate action using one or more of action risk, uncertainty, physical context, environmental context, or task significance;
select, under the candidate-action validation policy and based on the classifying, at least one predictive validator from the plurality of predictive validators;
cause the selected at least one predictive validator to evaluate the candidate action; and
selectively release, modify, limit, delay, decompose, reroute, or reject the candidate action based on an output of the selected at least one predictive validator and the release criteria.

32. The system of claim 31, wherein the one or more processors are configured to combine multiple categories into a composite risk score, policy label, or decision tier used to select the at least one predictive validator.

33. The system of claim 31, wherein the candidate-action validation policy specifies an amount of predictive evaluation, a validation resource, and a release criterion to be applied to the candidate action before motor release.

34. The system of claim 31, wherein the candidate-action validation policy causes a first candidate action to be evaluated by a lightweight collision or feasibility validator and causes a second candidate action having a greater validation burden to be evaluated by one or more higher-fidelity world models, dynamics predictors, physics simulations, or digital-twin resources.

35. The system of claim 31, wherein modifying or limiting the candidate action comprises imposing one or more operating limits including reduced speed, reduced force, increased clearance, a narrowed geofence, or a communication-confirmation requirement.

36. A non-transitory computer-readable medium storing instructions that, when executed by one or more processors of a physical artificial intelligence system, cause the one or more processors to:
intercept a candidate action before motor release;
select, under a candidate-action validation policy, one or more predictive validators from a plurality of predictive validators based on the candidate action and a physical context associated with the candidate action;
predict, using the selected one or more predictive validators, one or more physical consequences of executing the candidate action;
generate an execution directive for the candidate action based on the predicted one or more physical consequences;
log the candidate action, the predicted one or more physical consequences, the execution directive, and a measured execution outcome; and
refine, based on the logged information, at least one of a validator-selection rule, a validation criterion, a release threshold, a predictive validator, or an action-generation policy for use with a later candidate action.

37. The non-transitory computer-readable medium of claim 36, wherein refining comprises comparing at least one predicted physical consequence with a corresponding measured execution outcome and updating a confidence value, uncertainty estimate, validation criterion, or validator-selection rule based on a mismatch.

38. The non-transitory computer-readable medium of claim 36, wherein the instructions cause the one or more processors to perform the refining locally, remotely, or through a hybrid arrangement while maintaining a safety-critical release rule as fixed.

39. The non-transitory computer-readable medium of claim 36, wherein the logged information distinguishes among an approved action, a rejected action, a modified action, and an executed action, and wherein the refining uses the distinguished actions as different training examples.

40. The non-transitory computer-readable medium of claim 36, wherein the instructions further cause the one or more processors to provide information derived from the logged information to an action generator so that the action generator changes a later candidate action before predictive validation.
